(19) United States
(12) Patent Application Publication
(10) Pub. No.: US 2025/0340187 A1
(43) Pub. Date: Nov. 6, 2025

(54) PRESSURE CONTROL DEVICE, BRAKING SYSTEM, CONTROL METHOD

(71) Applicant: BREMBO S.p.A., Curno (Bergamo) (IT)

(72) Inventors: Roberto ARIENTI, Curno (Bergamo) (IT); Andrea ODONI, Curno (Bergamo) (IT); Luca PESENTI, Curno (Bergamo) (IT)

(73) Assignee: BREMBO S.p.A., Curno (Bergamo) (IT)

(21) Appl. No.: 18/862,187

(22) PCT Filed: May 5, 2023
(86) PCT No.: PCT/IB2023/054709

§ 371 Date: Nov. 1, 2024

(30) Foreign Application Priority Data
May 5, 2022 (IT) 102022000009176
May 5, 2022 (IT) 102022000009182

(51) Int. Cl. B60T 8/17; B60T 11/10; B60T 13/68; B60T 17/22; B62L 3/02; F16J 15/08

(52) U.S. Cl. CPC B60T 8/1706; B60T 11/101; B60T 13/686; B60T 17/22; B62L 3/023; F16J 15/0818; B60T 2270/402

(57) ABSTRACT

A pressure control device has a device body partially delimiting a first circuit side opening, a second circuit side opening, and a conduit having a first conduit portion connectable to a first circuit to receive a first circuit fluid at a first circuit pressure and a second conduit portion connectable to a second circuit to receive a second circuit fluid at a second circuit pressure. A pressure adjusting mechanism controls the first and/or second circuit pressure to reach an actuating pressure. When at least one of the first and second circuit pressures is lower than a threshold pressure, the pressure adjusting mechanism prevents fluid passages between the first and second conduit portions to actuate either a first or a second braking device. When the first and second circuit pressures are both higher than the threshold pressure, the pressure control connects the first and second conduit portions to actuate the first and second braking devices.

### FIELD OF THE INVENTION

The present invention relates to a pressure control device for a braking system, a braking system, and a method of controlling the actuating pressure of a braking system.

The patent application claims priority of Italian patent applications 102022000009182 and 102022000009176, the text and figures of which are fully incorporated in the present patent application.

### BACKGROUND ART

Braking systems are known, in which two braking devices are associated with one wheel, such as two brake calipers associated with two respective brake discs connected to two opposite sides of a wheel, for example. Such solutions are used on motorcycles, for example, to brake a front wheel.

In such systems, the two braking devices are hydraulically connected to the same pressure chamber of an actuating device, where the brake fluid pressurized in the pressure chamber actuates both braking devices, i.e., each hydraulic actuator of the braking device, with the same pressure. In other words, there is only one braking circuit in such systems which actuates at least two braking devices in parallel. Therefore, with these solutions, the actuating conditions of the two braking devices are the same because both braking devices are in direct fluid connection with the same pressure chamber. As a result, these solutions allow obtaining substantially uniform braking actions, as well as wear conditions, of the two braking devices.

Although with these solutions it is possible to actuate the two braking devices with the same pressure, thus ensuring uniformity of the braking action on the two sides of the wheel and of the wear conditions of the two braking devices, any hydraulic leakage results in a loss of pressure for the entire system, potentially precluding the operation thereof and thus preventing a user from braking the wheel on which the system acts, with severe reduction of driving safety in case of failure.

Therefore, the need is strongly felt in the industry to manufacture braking systems which involve the actuation of two braking devices per single wheel, in which an increased safety of use is ensured.

Furthermore, the need is strongly felt in the industry to manufacture braking systems in which the impairment of the use of one of the two braking devices does not affect the operation of the other braking device, and at the same time in which during normal conditions of use of the two braking devices, the conflicting need to keep the actuating conditions of the two braking devices as uniform as possible is met.

### SOLUTION

It is an object of the present invention to provide a pressure control device for a braking system which allows actuating at least two braking devices with the same actuating pressure during the normal operation of the at least two braking devices, and which allows actuating one braking device with an actuating pressure irrespective of a failure of another braking device, thus reducing, on the one hand, the variations in wear of the braking devices by preventing variations in pressure conditions in the actuation of the braking devices, and on the other hand, increasing the safety of the braking system in case of an inability to actuate a braking device.

This and other objects and advantages are achieved by a pressure control device according to claim 1, as well as by a braking system according to claim 12, as well as by a pressure control method according to claim 14.

Some advantageous embodiments are the subject of the dependent claims.

By virtue of the suggested solutions, it is possible to ensure automatic control of the actuating pressures of a first braking actuation device and a second braking actuation device.

By virtue of the suggested solutions, it is possible to balance and align the pressures of a first circuit connected to a first braking actuation device and a second circuit connected to a second braking actuation device, allowing a fluid connection between the two circuits when both circuits are at a pressure above a threshold pressure.

By virtue of the suggested solutions, it is possible to provide a mechanical-type pressure control device with small size and low cost.

By virtue of the suggested solutions, it is possible to respond to the need to ensure an operation of a first braking actuation device irrespective of the operation of a second braking actuation device, while responding to the additional conflicting need to ensure uniformity in the actuating conditions of the first braking actuation device and the second braking actuation device, by keeping the first braking actuation device and the second braking actuation device fluidly separated from each other as long as at least one of the first circuit pressure and the second circuit pressure is below a threshold pressure, and only when both the first circuit pressure and the second circuit pressure exceed the threshold pressure, the first braking actuation device and the second braking actuation device enter into fluid communication.

### DRAWINGS

Further features and advantages of the pressure control device, the braking system, and the control method will become apparent from the following description of preferred embodiments thereof, given by way of non-limiting indication, with reference to the accompanying drawings, in which:

FIG. 1 diagrammatically shows a braking system of known type, in which the same actuating device simultaneously controls a first braking device and a second braking device by means of a two-branch split line, e.g., a first brake caliper and a second brake caliper, forming a single braking circuit, in which the operation of the entire circuit is impaired if a failure occurs in one of the two branches and/or in one of the two braking devices;

FIG. 2 diagrammatically shows a braking system according to the present invention, in which the same actuating device controls, in parallel and independently by means of two separate pressure chambers, a first braking device and a second braking device, e.g., a first brake caliper and a second brake caliper associated with the same wheel of a vehicle, forming a first circuit and a second circuit, where a pressure control device according to the present invention is connected in parallel to the first circuit and the second circuit by keeping the two circuits fluidly separated when at least one of the first circuit pressure and the second circuit pressure is lower than a threshold pressure, thus allowing either the first braking device or the second braking device to be actuated irrespective of a failure in the second circuit or the first circuit, and putting the two circuits in fluid communication only when both the first circuit pressure and the second circuit pressure are higher than the threshold pressure, thus allowing the first braking device and the second braking device to be actuated with the same pressure;

FIGS. 3a-3d diagrammatically show the operation of the pressure control device according to an embodiment of the present invention, in which FIG. 3a shows the pressure actuating device when the braking system is at rest and the first circuit liquid and the second circuit liquid are not under pressure, where the pressure control mechanism is in a fully closed configuration; in which FIG. 3b shows the pressure actuating device which puts the first circuit and the second circuit fluid into fluid communication when both the first circuit pressure and the second circuit pressure are higher than the threshold pressure, where the pressure control mechanism is in a fully open configuration; FIG. 3c shows the pressure control device when a failure is present in the second circuit, where the first circuit pressure is above the threshold pressure, while the second circuit pressure is lower than the threshold pressure, where the pressure control mechanism is in a first closing configuration; FIG. 3d shows the pressure control device when a failure is present in the first circuit, where the second circuit pressure is above the threshold pressure, while the first circuit pressure is lower than the threshold pressure, where the pressure control mechanism is in a second closing configuration;

FIG. 4 shows an axonometric view of the pressure control device according to an embodiment of the present invention, in which a first side and an upper part of the body of the pressure control device can be seen;

FIG. 5 shows an axonometric view of the pressure control device in FIG. 4, in which a second side opposite to the first side and a lower part of the body of the pressure control device can be seen;

FIG. 6 shows an axonometric exploded view of the pressure control device in FIGS. 4 and 5, in which the body of the device is shown, which houses the pressure control mechanism and is configured to be connected to a first circuit and a second circuit by means of respective connecting portions;

FIG. 7 shows an axonometric view of the control device in FIG. 6, from a point of view opposite to that of FIG. 5;

FIG. 8 shows a section view of the control device in FIG. 4 taken along plane A-A, in which the pressure control mechanism housed inside the device body can also be seen, where the first piston and the second piston form a seal with the respective seat in which they are housed, by means of a respective polymer gasket fitted onto the body of the respective piston to form a dynamic and static seal with a wall of the respective seat, and by means of a respective piston surface adapted to form a static seal of geometric type against a respective seat surface;

FIG. 9 shows a section view of the device in FIG. 4 taken along plane A-A, in which the pressure control mechanism housed inside the device body can also be seen, where the first piston and the second piston form a seal with the respective seat in which they are housed, by means of a respective polymer gasket fitted onto the body of the respective first piston to form a dynamic and static seal with a wall of the respective seat, and a second polymer gasket inserted into an axial seat made on the head of the respective piston to form a static seal against a respective surface of the seat.

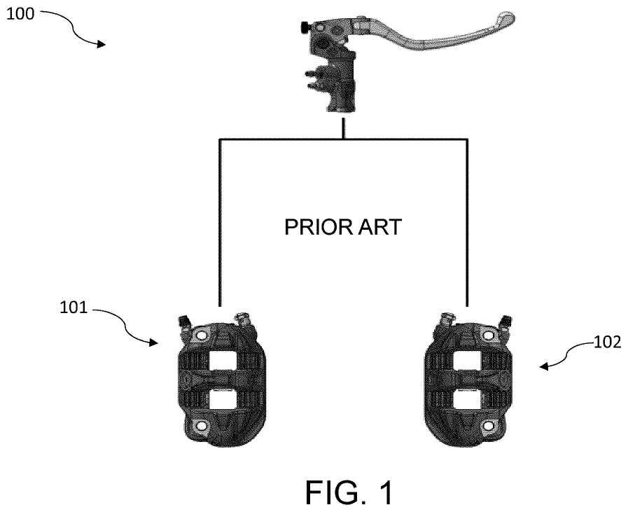

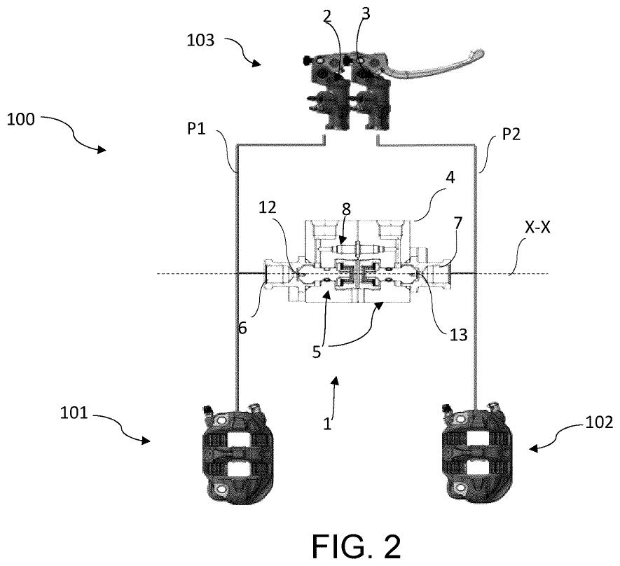

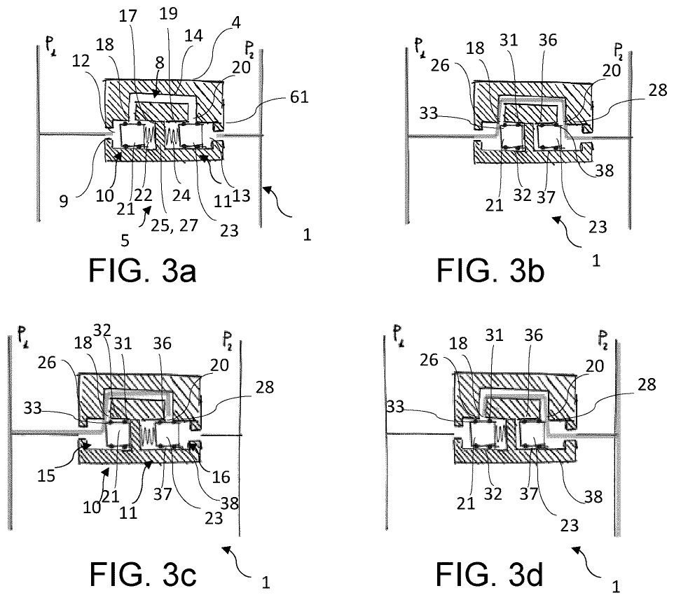

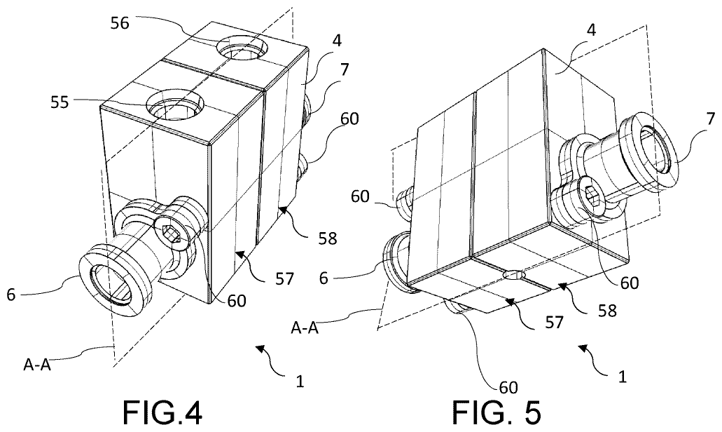

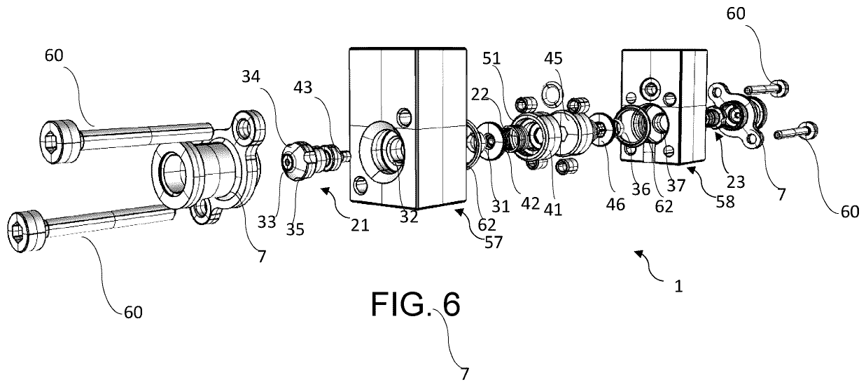

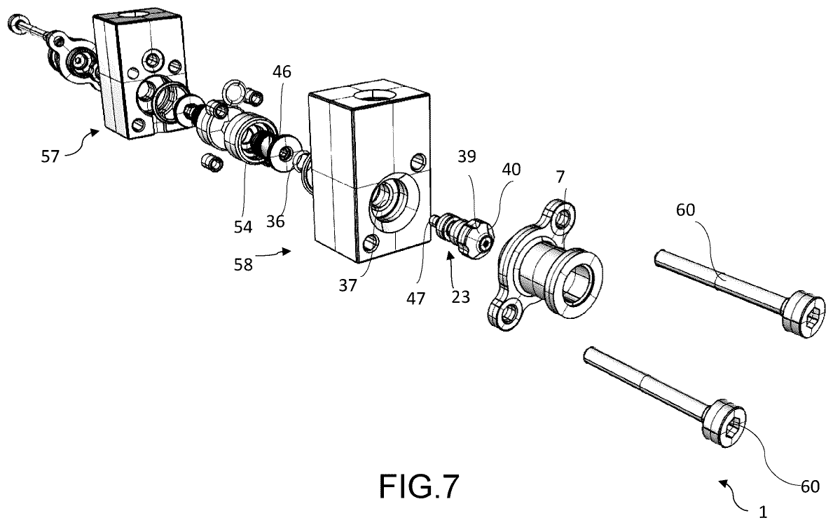

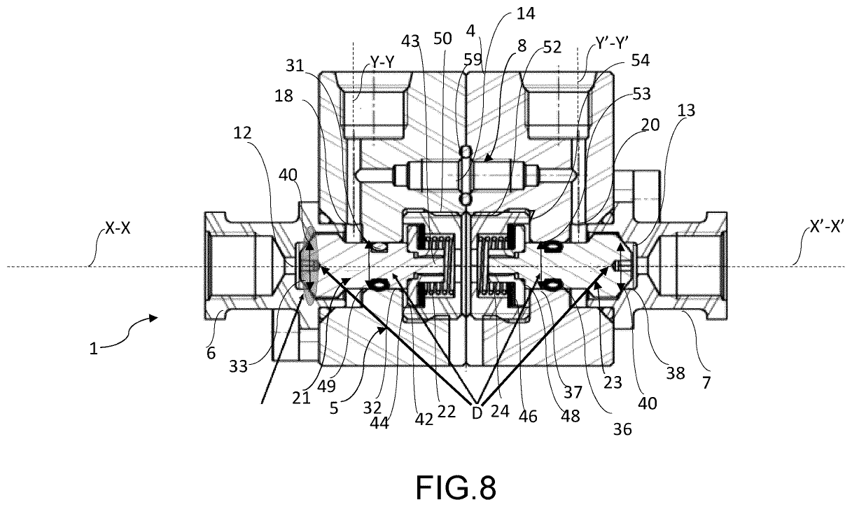

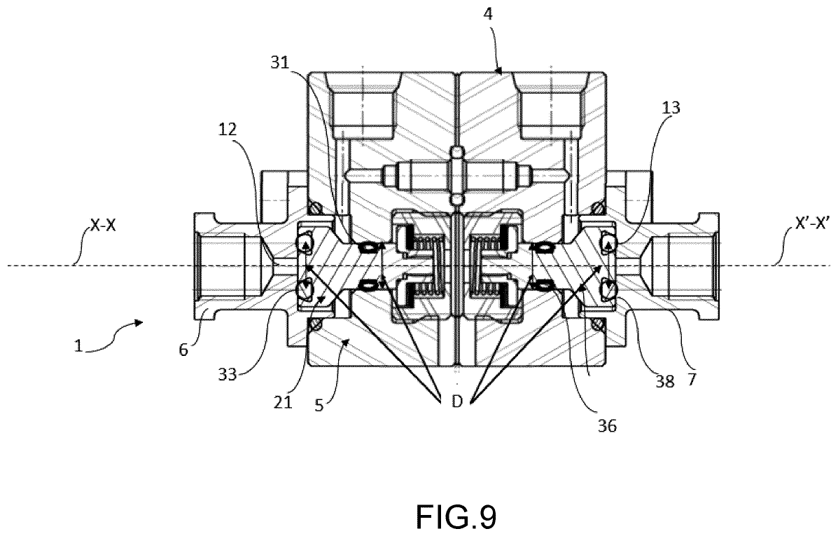

### DESCRIPTION OF SOME PREFERRED EMBODIMENTS

According to a general embodiment, a pressure control device for a braking system 100 is indicated by reference numeral 1.

Said pressure control device 1 comprises a device body 4 partially delimiting at least a first circuit side opening 9, at least a second circuit side opening 61, and at least one conduit 8 putting said at least a first circuit side opening 9 and said at least a second circuit side opening 61 in fluid communication. Said at least one conduit 8 comprises at least a first conduit portion 12 and at least a second conduit portion 13. According to an embodiment, said at least a first circuit side opening 9 and said at least a second circuit side opening 61 are arranged on opposite sides of said device body 4.

The first conduit portion 12 is fluidly connectable to a first circuit 2 to receive a first circuit fluid.

The second conduit portion 13 is fluidly connectable to a second circuit 3 to receive a second circuit fluid.

Said first circuit 2 comprises a first pressure chamber of a brake actuating device 103 to pressurize the first circuit fluid at a first circuit pressure P1, where the first pressure chamber is fluidly connected to a first braking actuation device 101 to brake a wheel of a vehicle.

Said second circuit 3 comprises a second pressure chamber of said brake actuating device 103 to pressurize the second circuit fluid at a second circuit pressure P2, where the second pressure chamber is fluidly connected to a second braking actuation device 102 to brake said wheel of a vehicle.

Said pressure control device 1 comprises a pressure control mechanism 5 configured to control the first circuit pressure P1 and/or the second circuit pressure P2 to reach an actuating pressure Pa.

Said pressure control mechanism 5 is housed at least partially in said conduit 8.

Advantageously, when at least one of said first circuit pressure P1 and said second circuit pressure P2 is lower than a threshold pressure Ps, said pressure control mechanism 5 is configured to prevent fluid passages between said first conduit portion 12 and said second conduit portion 13, or vice versa, so as to sustain at least one of said first circuit pressure P1 and said second circuit pressure P2, which is higher than said threshold pressure Ps, up to said actuating pressure Pa to actuate either the first braking device 101 or the second braking device 102.

Advantageously, when the first circuit pressure P1 and said second circuit pressure P2 are both higher than a threshold pressure Ps, said pressure control mechanism 5 is configured to fluidly connect the first conduit portion 12 and the second conduit portion 13, so as to align said first circuit pressure P1 and said second circuit pressure P2 said actuating pressure Pa to actuate the first braking device 101 and the second braking device 102 with said actuating pressure Pa.

By virtue of such a pressure control device 1, it is possible to automatically, mechanically, fluidly connect and isolate a first circuit and a second circuit in a reversible manner, so that, during a normal condition of use in which a sufficient circuit pressure to actuate the respective braking device can be reached in each of the two circuits, the first circuit and the second circuit are in fluid connection so as to work at the same pressure as if they were one circuit, and in case of a failure of either circuit, i.e., if the circuit pressure is insufficient to operate one of the two circuits and one of the two braking devices, the first circuit and the second circuit are separated thus preventing fluid passages between the two circuits, thus keeping the two circuits isolated, causing one of the two circuits to be pressurized irrespective of a failure on the other circuit.

By virtue of said pressure control mechanism 5, it is possible, in the absence of failures of the first circuit 2 or the second circuit 3, to avoid registering pressure differences between the first circuit pressure P1 and the second circuit pressure P2 which could occur if the first circuit 2 and the second circuit 2 were mutually separated, allowing the pressure conditions inside the first circuit 2 and the second circuit 3 to be aligned by putting the two circuits in fluid communication, actuating said first braking actuation device 101 and said second braking actuation device 102 with the same actuating pressure Pa. It is thus possible to align the wear conditions, as well 1 as the brake actuating conditions, of the first braking actuation device 101 and the second braking actuation device 102 acting for example on two opposite sides of the same wheel of a vehicle.

By virtue of said pressure control mechanism 5, it is possible to keep the two circuits fluidly separated, avoiding impairment of the braking system in case of a failure of one of the first circuit 2 and the second circuit 3, such as a fluid leakage, which would occur in the braking systems of prior art in which the two circuits 2, 3 are in fluid communication.

By virtue of the suggested solutions, the pressure control mechanism 5 is configured to allow the fluid in the working circuit 2, 3 to reach the actuating pressure Pa, irrespective of a failure of one of the two circuits 2, 3.

According to an embodiment, said pressure control mechanism 5 is configured to detect said first pressure P1 and said second pressure P2, preferably in a mechanical manner by means of at least one elastic device.

According to an embodiment, said conduit 8 comprises a third conduit portion 14 adapted to fluidly connect said at least a first conduit portion 12 and said at least a second conduit portion 13.

According to an embodiment, said pressure control mechanism 5 is configured to put said first conduit portion 12 in fluid communication with said third conduit portion 14 preventing fluid passages from said third conduit portion 14 to said second conduit portion 13, when said first conduit pressure P1 is higher than said threshold pressure Ps and said second conduit pressure P2 is lower than said threshold pressure Ps, so as to sustain said first circuit pressure P1 to actuate the first braking device 101 with said actuating pressure Pa.

According to an embodiment, said pressure control mechanism 5 is configured to put said second conduit portion 13 in fluid communication with said third conduit portion 14 preventing fluid passages from said third conduit portion 14 to said first conduit portion 12, when said second conduit pressure P2 is higher than said threshold pressure Ps and said first conduit pressure P1 is lower than said threshold pressure Ps, so as to sustain said second circuit pressure P2 to actuate the second braking device 102 with said actuating pressure Pa.

According to an embodiment, said pressure adjusting mechanism 5 comprises a first valve 10 housed at least partially in said first conduit portion 12.

According to an embodiment, said pressure adjusting mechanism 5 comprises a second valve 11 housed at least partially in said second conduit portion 13.

According to an embodiment, said third conduit portion 14 extends between a first valve side opening 18 in fluid communication with said first conduit portion 12 and a second valve side opening 20 in fluid communication with said second conduit portion.

According to an embodiment, said first valve 10 is configured to open and fluid-tightly close said first valve side opening 18 in a reversible manner.

According to an embodiment, when the first circuit pressure P1 is lower than said threshold pressure Ps, said first valve 10 closes said first valve side opening 18 preventing fluid passages from said first conduit portion 12 to said third conduit portion 14, and vice versa.

According to an embodiment, when the first circuit pressure P1 is higher than or equal to said threshold pressure Ps, said first valve 10 opens said first valve side opening 18 by fluidly connecting said first conduit portion 12 to said third conduit portion 14, and vice versa.

According to an embodiment, said second valve 11 is configured to open and fluid-tightly close said second valve side opening 20 in a reversible manner.

According to an embodiment, when the second circuit pressure P2 is lower than said threshold pressure Ps, said second valve 11 closes said second valve side opening 20 preventing fluid passages from said second conduit portion 12 to said third conduit portion 14, and vice versa.

According to an embodiment, when the second circuit pressure P2 is greater than or equal to said threshold pressure Ps, said second valve 11 opens said second valve side opening 20 by fluidly connecting said second conduit portion 12 to said third conduit portion 14, and vice versa.

According to an embodiment, said threshold pressure Ps is between 1 bar and 10 bars, preferably between 1 bar and 4 bars, even more preferably between 1 bar and 3 bars.

According to an embodiment, said pressure control device 1 comprises a first connecting portion 6 to fluidly connect the first conduit portion 12 to the first circuit 2.

According to an embodiment, said pressure control device 1 comprises a first connecting portion 6 to fluidly connect the first conduit portion 12 to the first circuit 2.

According to an embodiment, said pressure control device 1 comprises a second connecting portion 7 to connect the second conduit portion 13 to the second circuit 3.

According to a first embodiment, said first valve 10 comprises a first piston or first shutter element 21, housed in a first valve seat 15 delimited by said device body 4 and comprising at least partially said first conduit portion 12.

According to an embodiment, said first piston 21 is movable with respect to said device body 4, in said first valve seat 15, reversibly between a first conduit closing configuration and at least a first conduit opening configuration. According to an embodiment, said first piston 21 is constantly and/or elastically biased to said first conduit closing configuration so as to allow an opening of the first valve only when the first circuit pressure P1 reaches and/or exceeds the threshold pressure Ps.

According to an embodiment, in the first conduit closing configuration, when the first circuit pressure P1 is lower than the threshold pressure Ps, said first piston 21 forms a seal with a first wall 26 of said first valve seat 15 preventing a fluid passage from said first connecting portion 6 to said third conduit portion 14.

According to an embodiment, in the at least a first conduit opening configuration, when the first circuit pressure P1 is at least equal to or higher than said threshold pressure Ps, said first piston 21 is spaced apart from said first wall 26 and/or avoids forming a seal with said first wall 26, allowing a fluid connection between said first connecting portion 6 and said third conduit portion 14. According to an embodiment, in the at least a first conduit opening configuration, said first piston 21 delimits a first fluid passage with said device body 4, which skims at least one head portion of the first piston 21 allowing a fluid passage from said first connecting portion 6 to said third conduit portion 14 or vice versa. According to an embodiment, said first piston 21 is movable by a maximum stroke between 0.2 mm and 0.8 mm, preferably between 0.2 mm and 0.4 mm.

According to a second embodiment, said second valve 11 comprises a second piston or second shutter element 23 housed in a second piston seat 16 delimited by said device body 4 and comprising at least partially said second conduit portion 13.

According to an embodiment, said second piston 23 is movable with respect to said device body 4, in said second valve seat 16, reversibly between a second conduit closing configuration and at least a second conduit opening configuration. According to an embodiment, said second piston 23 is constantly and/or elastically biased to said second conduit closing configuration so as to allow an opening of the second valve only when the second circuit pressure P2 reaches and/or exceeds the threshold pressure Ps. According to an embodiment, said second piston 23 is movable by a maximum stroke between 0.2 mm and 0.8 mm, preferably between 0.2 mm and 0.4 mm.

According to an embodiment, in the second conduit closing configuration, when said second circuit pressure P2 is lower than said threshold pressure Ps, said second piston 23 forms a seal with a second wall 28 of said second valve seat 16 preventing a fluid passage from said second connecting portion 7 to said third conduit portion 14, or vice versa.

According to an embodiment, in the at least a second conduit closing configuration, when the second circuit pressure P2 is at least equal to or higher than said threshold pressure Ps, said second piston 23 is spaced apart from said second wall 28 and/or avoids forming a seal with said second wall 28 allowing a fluid connection from said first connecting portion 7 to said third conduit portion 14. According to an embodiment, in the at least a second conduit opening configuration, said second piston 23 delimits a second fluid passage with said device body 4, which at least partially skims a head portion of the second piston 23 allowing a fluid connection from said first connecting portion 7 to said third conduit portion 14 or vice versa.

According to an embodiment, said first valve 10 and said second valve 11 are one-way valves. According to an embodiment, said first valve 10 and said second valve 11 are driven only from one direction and are configured to form a seal in both directions. According to an embodiment, said first valve 10 and said second valve 11 switch from the respective closing configuration to the respective opening configuration only if the first circuit pressure P1 and the second circuit pressure P2 exceed the threshold pressure Ps, respectively. According to an embodiment, the first circuit pressure P1 does not affect the actuation of the second piston 23, and the second circuit pressure P2 does not affect the actuation of the first piston 21, because the second piston 23 has no effective area on which the pressure of the first fluid can act to move the second piston, and the first piston 21 has no effective area on which the pressure of the second fluid can act to move the first piston 21.

According to an embodiment, said first valve seat 15 extends along a longitudinal direction X-X of first valve. According to an embodiment, said second valve seat 16 extends along a longitudinal direction X′-X′ of second valve. According to an embodiment, said third conduit portion 14 engages in said first valve seat 15 according to a first engagement direction Y-Y, which is incident and/or transverse to said longitudinal direction X-X of first valve. According to an embodiment, said third conduit portion 14 engages in said second valve seat 16 according to a second engagement direction Y′-Y′, which is incident and/or transverse to said longitudinal direction X′-X′ of second valve. According to an embodiment, said longitudinal direction X-X of first valve and said longitudinal direction X′-X′ of second valve are parallel and/or coincident. According to an embodiment, said longitudinal direction X-X of first valve and said longitudinal direction X′-X′ of second valve are rectilinear. According to an embodiment, said longitudinal direction X-X of first valve and said longitudinal direction X′-X′ of second valve define the seat axis about which the walls of the device body delimiting the respective valve seats extend. According to an embodiment, said third a conduit portion 14 runs along direction which is parallel to said longitudinal direction X-X of first valve and said longitudinal direction X′-X′ of second valve.

According to an embodiment, said first valve 10 comprises a first elastic element 22 housed in said first valve seat 15.

According to an embodiment, said first elastic element 22 is interposed between said first piston 21 and said device body 4 along said longitudinal direction X-X of first valve, preferably a first bottom wall 25 of said first valve seat 15, so as to constantly bias said first piston 21 to said first conduit closing configuration.

According to an embodiment, said first elastic element 22 is sized so that when the first circuit pressure P1 is lower than the threshold pressure Ps, said first piston is in said first conduit closing configuration.

According to an embodiment, said second valve 11 comprises a second elastic element 24 housed in said second valve seat 16.

According to an embodiment, said second elastic element 24 is interposed between said second piston 23 and said device body 4 along said longitudinal direction X′-X′ of second valve, preferably a second bottom wall 26 of said second valve seat 16, so as to constantly bias the piston 23 to said second conduit closing configuration.

According to an embodiment, said second elastic element 24 is sized so that when the second circuit pressure P2 is lower than the threshold pressure Ps, said first piston is in said second conduit closing configuration.

According to an embodiment, said first piston 21 comprises a first gasket 31 of first piston, where said first gasket 31 of first piston is configured to form a seal with a first sliding wall 32 of said first valve seat 15 in any position of said first piston 21 between said at least a first conduit opening configuration and said first conduit closing configuration. According to an embodiment, said first gasket 31 of first piston is configured to fluidly isolate said first elastic element 22 from said third conduit portion 14 and/or said first circuit 2.

According to an embodiment, said second piston 23 comprises a first gasket 36 of second piston, where said first gasket 36 of second piston is configured to form a seal with a sliding wall 37 of said second valve seat 16 in any position of said second piston 23 between said at least a second conduit opening configuration and said second conduit closing configuration. According to an embodiment, said first gasket 36 of second piston is configured to fluidly isolate said second elastic element 24 from said third conduit portion 14 and/or said second circuit 3.

According to an embodiment, said first gasket 31 of first piston is a low-friction annular gasket fitted onto a first groove made on the piston body of said first piston 21. According to an embodiment, said first gasket 31 of first piston and/or said first gasket 36 of second piston is made of a polymer material compatible with a brake fluid.

According to an embodiment, said first gasket 31 of first piston and/or said first gasket 36 of second piston is a gasket with a V-profile, for example, or an O-ring.

According to an embodiment, said first gasket 36 of second piston is a second low-friction annular gasket fitted onto a second groove made on the piston body of said second piston 23.

According to an embodiment, said first piston 21 comprises a second gasket 33 of first piston configured to form a seal with said first wall 26 when said first piston 21 is in said first conduit closing configuration.

According to an embodiment, said second gasket 33 of first piston is spaced apart from said first wall 26 when said first piston 21 is in said first conduit opening configuration, thus opening said first fluid passage.

According to an embodiment, said second piston 23 comprises a second gasket 38 of second piston configured to form a seal with said second wall 28 when said second piston 23 is in said second conduit closing configuration.

According to an embodiment, said second gasket 38 of second piston is spaced apart from said second wall 28 when said second piston 38 is in said second conduit opening configuration, thus opening said second fluid passage.

According to an embodiment, said second gasket 33 of first piston is an annular gasket adapted to be fitted onto a first piston body. According to an embodiment, said second gasket 38 of second piston is a gasket adapted to be fitted onto a second piston body of said second piston 38.

According to an embodiment, said second gasket 33 of first piston and said second gasket 39 of second piston are annular O-rings or V-rings housed in a respective annular seat of the respective piston 21, 23. According to an embodiment, said second gasket 33 of first piston and/or said second gasket 39 of second piston is made of a polymer material compatible with a brake fluid.

According to an embodiment, said first piston 21 comprises a first piston head 34.

According to an embodiment, said second gasket 33 of first piston is an annular gasket adapted to be inserted into a respective axial annular seat made on said first piston head 34 as a groove accessible from a direction parallel to the longitudinal direction X-X of first seat. The second gasket 33 of first piston is thus configured to abut axially against the first wall 26 to form a seal.

According to an embodiment, said first piston head 34 comprises a first sealing surface 35 adapted to form a geometric seal by abutting against said first wall 26. According to an embodiment, the second gasket 33 of first piston is said first sealing surface 35. According to an embodiment, the second gasket 33 of first piston is a metal surface of the body of the first piston.

According to an embodiment, said first wall 26 and said first sealing surface 35 have a surface roughness such that they form a hydraulic seal when abutting against each other.

According to an embodiment, said second piston 23 comprises a second piston head 39.

According to an embodiment, said second gasket 38 of second piston is an annular gasket adapted to be inserted into a respective axial seat made on said second piston head 39 as a groove accessible from a direction parallel to the longitudinal direction X′-X′ of second seat. The second gasket 38 of second piston is thus configured to abut axially against the second wall 28 to form a seal.

According to an embodiment, said second piston head 39 comprises a second sealing surface 40 adapted to form a geometric seal by abutting against said second wall 28. According to an embodiment, said second gasket 38 of second piston is said second sealing surface 40. According to an embodiment, said second gasket 38 of second piston is a metal surface of the body of the second piston.

According to an embodiment, said second wall 28 and said second sealing surface 40 have a surface roughness such that they form a hydraulic seal when abutting against each other.

According to an embodiment, said first sealing surface 35 and said first wall 26, respectively, and said second sealing surface 40 and said second wall 28, respectively, form an annular geometric seal.

According to an embodiment, said first sealing surface 35 belongs to a first tapered surface of the first piston head 34.

According to an embodiment, said second sealing surface 40 belongs to a second tapered surface of the second piston head 39.

According to an embodiment, the respective piston head of each piston wedges into said first wall 26 or said second wall 28 with the respective annular gasket interposed therebetween.

According to an embodiment, said first wall 26 laterally and radially delimits, with respect to said longitudinal direction X-X of first seat, a portion of said first valve seat 15, preferably a first circuit side portion of said first conduit portion 12.

According to an embodiment, said first wall 26 axially delimits, orthogonally to said longitudinal direction X-X of first seat, a portion of said first valve seat 15, preferably a first circuit side portion of said first conduit portion 12. According to an embodiment, said first wall 26 is a circular crown orthogonal to said longitudinal direction X-X of first seat.

According to an embodiment, said first wall 26 is a connecting wall between two segments of said first conduit portion 12, which forms a first section narrowing of said first conduit portion 12.

According to an embodiment, said second wall 28 laterally delimits, radially with respect to said longitudinal direction X′-X′ of second seat, a portion of said second valve seat 15, preferably a second circuit side portion of said second conduit portion 13.

According to an embodiment, said second wall 28 axially delimits, orthogonally to said direction X′-X′ of second seat, a portion of said second valve seat 15, preferably a second circuit side portion of said second conduit portion 13. According to an embodiment, said second wall 28 is a circular crown orthogonal to said longitudinal direction X′-X′ of second seat.

According to an embodiment, said first wall 26 and said second wall 28 are tapered surfaces having a greater tapering angle than the taper angle of said first sealing surface 35 and said second sealing surface 40 with respect to the longitudinal extension direction X-X, X′-X′ of the respective valve seat.

According to an embodiment, said second sealing surface 40 and said second wall 28, said first sealing surface 35, and said first wall 26 are conical surfaces.

According to an embodiment, said second wall 28 is a connecting wall between two segments of said second conduit portion 13, which forms a second section narrowing of said second conduit portion 13.

According to an embodiment, said second gasket 33 of first piston and said first gasket 31 of first piston have the same sealing diameter D. According to an embodiment, said second gasket 38 of second piston and said first gasket 36 of second piston have the same sealing diameter D.

Section narrowing means a radial narrowing of the conduit moving forward along the longitudinal direction of the conduit and/or the valve seat.

According to an embodiment, said first connecting portion 6 partially delimits said first conduit portion 12 with said first wall 26. According to an embodiment, said second connecting portion 7 partially delimits said second conduit portion 13 with said second wall 28.

According to an embodiment, said pressure adjusting mechanism 5 comprises a first reinforcement 41 in which said first elastic element 22 is housed, where said first reinforcement 41 forms a first bottom of the first valve seat 15. According to an embodiment, said pressure adjusting mechanism 5 comprises a first transmission element 42.

According to an embodiment, said first elastic element 22 is connected to said first piston 21 by means of said first transmission element 42.

According to an embodiment, said first transmission element 42 is adapted to receive a first piston engagement portion 43 to connect to the first piston 21 by positive coupling and/or by interference and/or by interlocking/engagement.

According to an embodiment, said first transmission element 42 is adapted to abut against a first piston thrust portion 44.

According to an embodiment, said pressure adjusting mechanism 5 comprises a second reinforcement 45 in which said second elastic element 24 is housed, where said first reinforcement 45 forms a second bottom of the second valve seat 16.

According to an embodiment, said pressure adjusting mechanism 5 comprises a second transmission element 46.

According to an embodiment, said second elastic element 24 is connected to said second piston 23 by means of said second transmission element 46.

According to an embodiment, said second transmission element 46 is adapted to receive a second piston engagement portion 47 to connect to the second piston 23 by positive coupling and/or by interference and/or by interlocking/engagement.

According to an embodiment, said second transmission element 46 adapted to abut against a second piston thrust portion 48.

According to an embodiment, said first elastic element 22 and said second elastic element 24 comprise a first spring and a second spring, respectively.

According to an embodiment, said first spring and said second spring are a wire spring.

According to an embodiment, said wire spring is sized so as to allow the respective piston 21, 23 to retract when the respective pressure P1, P2 applied by the respective fluid on the surface facing the first circuit or the second circuit of the piston head is higher than the threshold pressure Ps1.

According to an embodiment, said first transmission element 42 and said second transmission element 46 have a first T-shaped body and a second T-shaped body, respectively, having a T-shaped section and having a longitudinal through-hole.

According to an embodiment, said first T-shaped body and/or said first transmission element 42 has a first elongated stem and a first enlarged head.

According to an embodiment, the first elongated stem is accommodated inside the turns of the first spring, where an end turn of the first spring abuts against an outer first-head surface of said first enlarged head.

According to an embodiment, said first elongated stem internally defines a first engagement seat to engage said first piston engagement portion 43 by interference and/or by positive coupling and/or by engagement. According to an embodiment, said first piston thrust portion 44 abuts against an inner first-head surface of said first enlarged head.

According to an embodiment, said second T-shaped body and/or said second transmission element 46 has a second elongated stem and a second enlarged head.

According to an embodiment, the second elongated stem is accommodated inside the turns of the second spring, where an end turn of the second spring abuts against an outer second-head surface of said second enlarged head.

According to an embodiment, said second elongated stem internally defines a second engagement seat to engage said second piston engagement portion 47 by interference and/or by positive coupling and/or by engagement.

According to an embodiment, said second piston thrust portion 48 abuts against an inner second-head surface of said second enlarged head.

According to an embodiment, the first spring and the second spring are fixed to the first bottom wall 25 and the second bottom wall 27, respectively.

According to an embodiment, said first transmission element 42 is configured to abut against a respective abutment portion of the first reinforcement 41 when said first piston 21 is in said first conduit opening configuration, defining the maximum stroke by which said first piston can move between the first conduit closing configuration and the first conduit opening configuration.

According to an embodiment, the outer first-head surface of said first enlarged head of the first transmission element 41 is configured to abut against the abutment portion of the first reinforcement 41 when said first piston 21 is in said first conduit opening configuration. According to an embodiment, the outer first-head surface of said first enlarged head of the first transmission element 41, when said first piston 21 is in said first conduit closing configuration, is at a distance equal to the maximum stroke of the first piston from the abutment portion of the first reinforcement 41.

According to an embodiment, said second transmission element 46 is configured to abut against a respective abutment portion of the second reinforcement 45 when the second piston 23 is in said second conduit opening configuration, defining the maximum stroke by which the first piston can move between the second conduit closing configuration and the second conduit opening configuration.

According to an embodiment, the outer second-head surface of said second enlarged head of the second transmission element is configured to abut against the respective abutment portion of the second reinforcement 45 when the second piston 23 is in said second conduit opening configuration. According to an embodiment, the outer second-head surface of said second enlarged head of the second transmission element, when the second piston 23 is in said second conduit closing configuration, is at a distance equal to the maximum stroke of the second piston from the abutment portion of the second reinforcement 45.

According to an embodiment, said first valve seat 15 comprises at least partially said first conduit portion 12 and a first bottom portion 17. According to an embodiment, said first bottom wall 25 separates said first valve seat 15 and said second valve seat 16. According to an embodiment, said first bottom portion 17 comprises said first bottom wall 25. According to an embodiment, said first bottom wall 25 comprises at least a first bottom opening in fluid communication with the external environment without compressing air or fluids in the first bottom portion 17.

According to an embodiment, said third conduit portion 14 leads with said first valve side opening 18 into said first valve seat 15. According to an embodiment, said first valve side opening 18 is defined on a first side wall 29 of said first conduit portion 12.

According to an embodiment, at least one portion of said first valve seat 15 is fluidly connectable to at least one portion of said second valve seat 16 by means of said third conduit portion 14.

According to an embodiment, said second valve seat 16 comprises at least partially said second conduit portion 13 and a second bottom portion 19. According to an embodiment, said second bottom portion 19 comprises said second bottom wall 27. According to an embodiment, said second bottom wall 27 separates said second valve seat 16 and said first valve seat 15. According to an embodiment, said second bottom wall 28 comprises at least a second bottom opening in fluid communication with the external environment to allow said piston to retract without compressing air or fluids in the second bottom portion 17. According to an embodiment, said third conduit portion 14 leads with said second valve side opening 20 into said second valve seat 16, where said second valve side opening 20 is defined on a second side wall 30 of said second conduit portion 13.

According to an embodiment, said first bottom portion 17 comprises a first segment 49 with enlarged section and a first segment 50 with reduced section. According to an embodiment, said first piston 21 is sealingly slides in said first segment 50 with reduced section against said first sliding wall 32. According to an embodiment, said first reinforcement 41 is housed in said first segment 49 with enlarged section. According to an embodiment, said first reinforcement 41 comprises said first bottom wall 25. According to an embodiment, said first reinforcement 41 comprises a first axial edge 51 opposite to said first bottom wall 25.

According to an embodiment, said second bottom portion 19 comprises a second segment 52 with enlarged section and a second segment 53 with reduced section, where said second piston 23 sealingly slides in said second segment 53 with reduced section against said second sliding wall 37. According to an embodiment, said second reinforcement 45 is housed in said second segment 52 with enlarged section. According to an embodiment, said second reinforcement 45 comprises said second bottom wall 27, where said second reinforcement 45 comprises a second edge 54 opposite to said second bottom wall 27. According to an embodiment, a locking gasket is interposed between said first bottom wall 25 and said second bottom wall 27.

According to an embodiment, said first transmission element 42 is configured to abut against a respective abutment portion of the first reinforcement 41 when said first piston 21 is in said first conduit opening configuration, defining the maximum stroke by which said first piston can move between the first conduit closing configuration and the first conduit opening configuration.

According to an embodiment, said second transmission element 46 is configured to abut against a respective abutment portion of the second reinforcement 45 when the second piston 23 is in said second conduit opening configuration, defining the maximum stroke by which the first piston can move between the second conduit closing configuration and the second conduit opening configuration.

According to an embodiment, said pressure balancing device 1 comprises a first bleeding portion 55 and a second bleeding portion 56 adapted to connect to said third conduit portion 14 so as to bleed said pressure balancing device 1. According to an embodiment, said first bleeding portion 55 and said second bleeding portion 56 are made in one piece with said device body 4.

According to an embodiment, said first connecting portion 6 and said second connecting portion 7 are made in one piece separate from said device body 4 and are sealingly connected to said device body 4 at said at least a first circuit side opening 9 and said at least a second circuit side opening 61, for example by means of the interposition of ring gaskets 62 with said device body 4. According to an embodiment, said first connecting portion 6 and said second connecting portion 7 are made in one piece with said device body 4 and delimit said at least a first circuit side opening 9 and said at least a second circuit side opening 61, respectively.

According to an embodiment, said device body 4 comprises a first half-body 57 and a second half-body 5. According to an embodiment, the first half-body 57 comprises said first conduit portion 12, a first half of said third conduit portion 14, said the first valve seat 15. According to an embodiment, the second half-body 58 comprises said second conduit portion 13, a second half of said third conduit portion 14, said the second valve seat 16. According to an embodiment, said first half of said third conduit portion 14 is fluid-tightly connected to said second half of said third conduit portion 14, for example by means of an interposed gasket 59. According to an embodiment, the first half-body 57 is constrained to the second half-body 58 by means of at least a first pair of connecting elements 60, for example of the screw-type, and/or a second pair of connecting elements 60, for example of the screw-type, accommodated in respective connecting element seats made in the first half-body 57 and the second half-body 58.

The present invention also relates to a braking system generally indicated by reference numeral 100.

The braking system 100 comprises at least a first circuit 2 comprising at least a first pressure chamber of a brake actuating device 103 fluidly connected to a first braking actuation device 101 to brake a wheel of a vehicle. The braking system 100 comprises at least a second circuit 3 comprising at least a second pressure chamber of said brake actuating device 103 fluidly connected to a second braking actuation device 102 to brake said wheel. The braking system 100 comprises a pressure control device 1 according to any one of the embodiments described above, connected to said first circuit 2 and said second circuit 3 in parallel with said first braking actuation device 101 and said second braking actuation device 102 and to said first pressure chamber and said second pressure chamber.

By virtue of the system 100, it is possible, by activating said brake actuating device 103, when the first circuit pressure P1 and the second circuit pressure P2 are higher than said threshold pressure Ps, to align the first circuit pressure P1 and the second circuit pressure P2 with the actuating pressure Pa, to actuate each braking actuation device 101, 102 with said actuating pressure Pa.

By virtue of the system 100, it is possible, by activating said brake actuating device 103, to actuate only one of said first braking actuation device 101 and said second braking actuation device 102 with said actuating pressure Pa when one of said first circuit pressure P1 and said second circuit pressure P2 is lower than said threshold pressure Ps.

According to an embodiment, said brake actuating device 103 is a lever-operated tandem master cylinder, or said brake actuating device 103 comprises two separate lever-operated brake master cylinders.

According to an embodiment, each braking actuation device 101, 102 is a brake caliper connected from opposite sides to said wheel.

According to an embodiment, said wheel is a front wheel of a motorcycle.

The present invention also relates to a method of controlling the actuating pressure of at least one braking actuation device in a braking system 100. The braking system 100 comprises at least a first circuit 2 comprising at least a first pressure chamber of a brake actuating device 103 fluidly connected to a first braking actuation device 101 to brake a vehicle; at least a second circuit 3 comprising at least a second pressure chamber of said brake actuating device 103 fluidly connected to a second braking actuation device 102 to brake said vehicle.

Said method comprises the steps of:
providing a pressure control device 1 comprising a first conduit portion 12 fluidly connectable to the first circuit 2 and a second conduit portion 13 fluidly connectable to the second circuit 3,
connecting said first circuit 2 to said second circuit 3 with said pressure control device 1 arranged in parallel with said first braking actuation device 101 and said second braking actuation device 102 and to said first pressure chamber and said second pressure chamber, by fluidly connecting the first conduit portion 12 to the first circuit 2 and the second conduit portion 13 to the second circuit 3,
actuating the brake actuating device 103 by compressing a first circuit fluid in the first conduit portion 12 at a first circuit pressure P1 and a second circuit fluid in the second conduit portion 13 at a second circuit pressure P2,
until at least one of the first circuit pressure P1 and the second circuit pressure P2 is lower than a threshold pressure Ps, preventing fluid passages between the first conduit portion 12 and the second conduit portion 13, and so as to sustain the first circuit pressure P1 or the second circuit pressure P2 to reach the actuating pressure Pa, and actuate the braking actuation device 101 or the second braking actuation device 102 with said actuating pressure Pa,
and when the first circuit pressure P1 and the second circuit pressure P2 are higher than a threshold pressure Ps, fluidly connecting the first conduit portion 12 and the second conduit portion 13, so as to align the first circuit pressure P1 and the second circuit pressure P2 with an actuating pressure Pa and actuate with said actuating pressure Pa each braking actuation device 101, 102 with said actuating pressure Pa.

According to a mode of operation, said pressure control device 1 is a device according to one of the embodiments described above. According to a mode of operation, said system 100 is a system according to one of the embodiments described above.

According to a general embodiment, a pressure control device 1 for a braking system 100 comprises a device body 4 in which at least one conduit 8, comprising at least a first conduit portion 12 and at least a second conduit portion 13 is defined.

The first conduit portion 12 is fluidly connectable to a first circuit 2 to receive a first circuit fluid.

Said first circuit 2 comprises a first pressure chamber of a brake actuating device 103 to pressurize the first circuit fluid at a first circuit pressure P1, where the first pressure chamber is fluidly connected to a first braking actuation device 101 to brake a wheel of a vehicle.

The second conduit portion 13 is fluidly connectable to a second circuit 3 to receive a second circuit fluid, where said second circuit 3 comprises a second pressure chamber of said brake actuating device 103 to pressurize the second circuit fluid at a second circuit pressure P2.

The second pressure chamber is fluidly connected to a second braking actuation device 102 to brake said wheel of vehicle.

Said pressure control device 1 for a braking system 100 further comprises a pressure control mechanism 5 configured to control the first circuit pressure P1 and/or the second circuit pressure P2 to reach an actuating pressure Pa.

Said pressure control mechanism 5 is housed at least

partially in said conduit 8.

Said pressure control mechanism 5 is configured to fluid-tightly separate a first volume V1 delimited by said first conduit portion 12 from a second volume V2 delimited by said second conduit portion 13.

Said pressure control mechanism 5 is configured to control a relative volume variation of the first volume V1 with respect to the second volume V2, or vice versa, within a maximum relative volume variation by preventing fluid passages from said first conduit portion 12 to said second conduit portion 13, or vice versa, so as to align said first circuit pressure P1 and said second circuit pressure P2 with said actuating pressure Pa, when said first circuit pressure P1 and said second circuit pressure P2 are sufficient to actuate the respective braking device 101, 102, and so as to sustain said first circuit pressure P1 or said second circuit pressure P2 reaching said actuating pressure Pa, preventing said relative volume variation beyond said maximum relative volume variation by avoiding fluid passages from said first conduit portion 12 to said second conduit portion 13, or vice versa, when either the second circuit pressure P2 or the first circuit pressure P1 is insufficient to actuate the respective braking device 101, 102.

According to an embodiment, said pressure control device 1 comprises a first connecting portion 6 to fluidly connect the first conduit portion 12 to the first circuit 2, and a second connecting portion 7 to connect the second conduit portion 13 to the second circuit 3.

Said pressure control mechanism 5 comprises a membrane 9, which fluid-tightly separates said first conduit portion 12 and said second conduit portion 13.

Said membrane 9 is elastically movable through elastic means between a first configuration and a second configuration about a resting configuration at least along a longitudinal extension direction X-X of said conduit 8.

In said resting configuration, said membrane 9 is in a resting position.

Between said resting configuration and said first configuration, at least one portion of said membrane 9 is moved forward by a first stroke along said longitudinal extension direction X-X toward said first connecting portion 6 within a first maximum stroke, where, between said resting configuration and said second configuration, said at least one portion of said membrane 9 is moved forward by a second stroke along said longitudinal extension direction X-X toward said second connecting portion 7 within a second maximum stroke, by increasing or decreasing the relative volume variation of the first volume V1 with respect to the second volume V2, or vice versa.

According to an embodiment, said membrane 9 comprises a membrane body 10, where said membrane body 10 comprises a membrane edge 11 constrained in a fluid-tight manner to a conduit side wall 31 of said conduit 8 in a fixed position.

Said membrane body 10 comprises said elastic means and is elastically deformable in the direction of said first connecting portion 6 and in the direction of said second connecting portion 7 by a respective deformation corresponding to said first maximum stroke and said second stroke.

According to an embodiment, said maximum relative volume variation is equal to the volume swept by said membrane 9 in the movement from said resting configuration to said first configuration when the first stroke is the first maximum stroke or in the movement from said resting configuration to said second configuration when the second stroke is the second maximum stroke.

According to an embodiment, said pressure control mechanism 5 comprises a shell 14 defining a membrane seat 15 for membrane 9 therein, where the membrane 9 is movable within said maximum relative volume variation, where the shell 14 comprises a first half-shell 16 and a second half-shell 17, where the membrane 9 is interposed between the first half-shell 16 and the second half-shell 17, forming a frame for said membrane 9 which prevents the membrane 9 from moving outside the membrane seat 15.

According to an embodiment, the first half-shell 16 and the second half-shell 17 each comprise at least one shell opening 18 such that the membrane has a first membrane surface 19 at least partially directly facing the first connecting portion 6 contacted by the first circuit fluid and a second membrane surface 20 at least partially directly facing the second connecting portion 7 contacted by the second circuit fluid.

According to an embodiment, said first half-shell 16 and said second half-shell 17 are permeable to said first circuit fluid and said second circuit fluid.

According to an embodiment, said membrane 9 is impermeable to said first circuit fluid and said second circuit fluid.

According to an embodiment, said first half-shell 16 comprises a first plate-like body 21 and a first annular flange 22.

Said second half-shell 17 comprises a second plate-like body 23 and a second annular flange 24.

Said first plate-like body 21 comprises a first annular edge 25 facing the side wall of said conduit 8.

Said first annular flange 22 projects from said first plate-like body 21 in the direction of said second connecting portion 7 at a first radial distance from said first annular edge 25.

Said second plate-like body 23 comprises a second annular edge 26 facing the side wall of said conduit 8.

Said second annular flange 24 projects from said second plate-like body 23 in the direction of said first connecting portion 6 at a second radial distance from said second annular edge 26 equal to said first radial distance, so as to face said first annular flange 22.

Said first annular flange 22 fluid-tightly abuts against said second annular flange 24 with said membrane 9 interposed therebetween.

Said first annular edge 25, said first annular flange 22, said second annular flange 24, and said second annular edge 26 form a U-shaped profile adapted to accommodate a sealing gasket adapted to form a seal with the side wall of said conduit 8.

Said membrane edge 11 is a sealing gasket configured to form a seal with a wall of said conduit, where said membrane edge 11 has a greater thickness than the thickness of the membrane body 10.

Each plate-like body 21, 23 is crossed by at least one opening 18, preferably a plurality of openings 18.

According to an embodiment, said membrane 9 comprises a plurality of valleys 27 and a plurality of ridges 28 so as to increase the surface facing the first circuit and the second circuit, preferably said plurality of valleys 27 and said plurality of ridges 28 are concentric.

According to an embodiment, said membrane 9 is bellows-shaped.

According to an embodiment, said device body 4 comprises a first half-body 29 and a second half-body 30, connected to each other, for example by means of threading, such as by a threaded outer surface of first half-body and a threaded inner surface of second half-body, or vice versa.

Said first half-body 29 delimits said first conduit portion 12.

Said second half-body 30 delimits said second conduit portion 13.

According to an embodiment, said device body 4 delimits a third conduit portion partially comprising the first conduit portion 12 and the second conduit portion 13 and having a greater section than the sections of the first conduit portion 12 and the second conduit portion 13 at opposite ends of the conduit 8, defining a section enlargement of the conduit 8.

According to an embodiment, said device body 4 defines a mechanism seat radially delimited with respect to the longitudinal conduit direction X-X by a conduit side wall 31, and delimited along said conduit extension direction X-X by a first radial crown 32 and a second radial crown 33 of said second half-body 30, where said pressure control mechanism 5 forms a radial seal with said conduit side wall 31 and axially abuts against said first radial crown 32 and said second radial crown 33.

According to an embodiment, a braking system 100 comprises:
at least a first circuit 2 comprising at least a first pressure chamber of a brake actuating device 103 fluidly connected to a first braking actuation device 101 to brake a wheel of a vehicle,
at least a second circuit 3 comprising at least a second pressure chamber of said brake actuating device 103 fluidly connected to a second braking actuation device 102 to brake said wheel,
a pressure control device 1 according to any one of the embodiments described above, connected to said first circuit 2 and said second circuit 3 in parallel with said first braking actuation device 101 and said second braking actuation device 102 and to said first pressure chamber and said second pressure chamber so that, by activating said brake actuating device 103, each braking actuation device 101, 102 is actuated with said actuating pressure Pa, when the first circuit pressure P1 and the second circuit pressure P2 are sufficient to actuate the respective braking actuation device 101, 102, and one of said first braking actuation device 101 and said second braking actuation device 102 is actuated with said actuating pressure Pa when one of said first circuit pressure P1 and said second circuit pressure P2 is insufficient to actuate the respective braking actuation device 101, 102.

According to an embodiment, said brake actuating device 103 is a lever-operated tandem master cylinder, or said brake actuating device 103 comprises two separate lever-operated brake master cylinders.

According to an embodiment, each braking actuation device 101, 102 is a brake caliper connected from opposite sides to said wheel.

According to an embodiment, said wheel is a front wheel of a motorcycle.

According to a general embodiment, a method of controlling the actuating pressure of at least one braking actuation device in a braking system 100 is described below, where said braking system 100 comprises:
at least a first circuit 2 comprising at least a first pressure chamber of a brake actuating device 103 fluidly connected to a first braking actuation device 101 to brake a vehicle,
at least a second circuit 3 comprising at least a second pressure chamber of said brake actuating device 103 fluidly connected to a second braking actuation device 102 to brake said vehicle.

Said method comprises the steps of:
providing a pressure control device 1 comprising a first conduit portion 12 fluidly connectable to the first circuit 2 and a second conduit portion 13 fluidly connectable to the second circuit 3, where said first conduit portion 12 is fluidly isolated from said second conduit portion 13, where said first conduit portion 12 delimits a first volume V1, and where said second conduit portion 13 delimits a second volume V2,
connecting said first circuit 2 to said second circuit 3 with said pressure control device 1 arranged in parallel with said first braking actuation device 101 and said second braking actuation device 102 and to said first pressure chamber and said second pressure chamber, by fluidly connecting the first conduit portion 12 to the first circuit 2 and the second conduit portion 13 to the second circuit 3,
actuating the brake actuating device 103 by compressing a first circuit fluid in the first conduit portion 12 at a first circuit pressure P1 and a second circuit fluid in the second conduit portion 13 at a second circuit pressure P2,
perform a relative volume variation of the first volume V1 with respect to the second volume V2 within a maximum relative volume variation so as to
align the first circuit pressure P1 and the second circuit pressure P2 with an actuating pressure Pa and actuate with said actuating pressure Pa each braking actuation device 101, 102 with said actuating pressure Pa, when the first circuit pressure P1 and the second circuit pressure P2 are sufficient to actuate the respective braking actuation device 101, 102,
and so as to
sustain the first circuit pressure P1 or the second circuit pressure P2 to reach the actuating pressure Pa, preventing the relative volume variation of the first volume V1 and the second volume V2 beyond said maximum relative volume variation, and actuate the braking actuation device 101 or the second braking actuation device 102 with said actuating pressure Pa, and when the second circuit pressure P2 or the first circuit pressure P1 is insufficient to actuate the second braking actuation device 102 or the first braking actuation device 101.

### LIST OF REFERENCE SIGNS

1 Pressure control device
2 first circuit
3 second circuit
4 device body
5 pressure adjusting mechanism
6 first connecting portion
7 second connecting portion
8 conduit
9 first circuit side opening
10 first valve
11 second valve
12 first conduit portion
13 second conduit portion
14 third conduit portion
15 first valve seat
16 second valve seat
17 first bottom portion
18 first valve side opening
19 second bottom portion
20 second valve side opening
21 first piston or first shutter element
22 first elastic element
23 second piston or second shutter element
24 second elastic element
25 first bottom wall
26 first wall
27 second bottom wall
28 second wall
29 first side wall
30 second side wall
31 first gasket of first piston
32 first sliding wall
33 second gasket of first piston
34 first piston head
35 first sealing surface
36 first gasket of second piston
37 second sliding wall
38 second gasket of second piston
39 second piston head
40 second sealing surface
41 first reinforcement
42 first transmission element
43 first piston engagement portion
44 first piston thrust portion
45 second reinforcement
46 second transmission element
47 second piston engagement portion
48 second piston thrust portion
49 first segment with enlarged section
50 first segment with reduced section
51 first axial edge
52 second segment with enlarged section
53 first segment with reduced section
54 second axial edge
55 first bleeding portion
56 second bleeding portion
57 first half-body
58 second half-body
59 interposed gasket
60 connecting elements
61 second circuit side opening
62 ring gasket
100 braking system
101 first braking device or first brake caliper
102 second braking device or second brake caliper
103 brake actuating device
P1 first circuit pressure
P2 second circuit pressure
Ps threshold pressure
Pa actuating pressure
D sealing diameter
X-X longitudinal direction of first seat
X′-X′ longitudinal direction of second seat
Y-Y first engagement direction
Y′-Y′ second engagement direction

1-14. (canceled)

15. A pressure control device for a braking system, comprising:
a device body partially delimiting at least a first circuit side opening, at least a second circuit side opening, and at least one conduit putting said at least a first circuit side opening and said at least a second circuit side opening in fluid communication, wherein said at least one conduit comprises at least a first conduit portion and at least a second conduit portion,
wherein the first conduit portion is fluidly connectable to a first circuit to receive a first circuit fluid, wherein said first circuit comprises a first pressure chamber of a brake actuating device to pressurize the first circuit fluid at a first circuit pressure, wherein the first pressure chamber is fluidly connected to a first braking actuation device to brake a wheel of a vehicle,
wherein the second conduit portion is fluidly connectable to a second circuit to receive a second circuit fluid, wherein said second circuit comprises a second pressure chamber of said brake actuating device to pressurize the second circuit fluid at a second circuit pressure, wherein the second pressure chamber is fluidly connected to a second braking actuation device to brake the wheel of the vehicle, and
a pressure adjusting mechanism configured to control the first circuit pressure and/or the second circuit pressure to reach an actuating pressure,
wherein said pressure adjusting mechanism is at least partially housed in said at least one conduit, and wherein
when at least one of said first circuit pressure and said second circuit pressure is lower than a threshold pressure, said pressure adjusting mechanism is configured to prevent fluid passages between said first conduit portion and said second conduit portion, or vice versa, so as to sustain at least one of said first circuit pressure and said second circuit pressure which is higher than said threshold pressure up to said actuating pressure to actuate either the first braking actuation device or the second braking actuation device, and
when the first circuit pressure and the second circuit pressure are both higher than the threshold pressure, said pressure adjusting mechanism is configured to fluidly connect the first conduit portion and the second conduit portion, so as to align said first circuit pressure and said second circuit pressure with said actuating pressure to actuate the first braking actuation device and the second braking actuation device with said actuating pressure.

16. The pressure control device of claim 15, wherein
said at least one conduit further comprises a third conduit portion adapted to fluidly connect said first conduit portion and said second conduit portion, wherein
said pressure adjusting mechanism comprises a first valve at least partially housed in said first conduit portion and a second valve at least partially housed in said second conduit portion, wherein
said third conduit portion extends between a first valve side opening in fluid communication with said first conduit portion and a second valve side opening in fluid communication with said second conduit portion, wherein
said first valve is configured to open and fluid-tightly close said first valve side opening in a reversible manner, wherein when the first circuit pressure is lower than said threshold pressure, said first valve closes said first valve side opening preventing fluid passages from said first conduit portion to said third conduit portion, and vice versa, and wherein when the first circuit pressure is either higher than or equal to said threshold pressure, said first valve opens said first valve side opening by fluidly connecting said first conduit portion to said third conduit portion, and vice versa, and wherein
said second valve is configured to open and fluid-tightly close said second valve side opening in a reversible manner, wherein when the second circuit pressure is lower than said threshold pressure, said second valve closes said second valve side opening preventing fluid passages from said second conduit portion to said third conduit portion, and vice versa, and wherein when the second circuit pressure is either higher than or equal to said threshold pressure, said second valve opens said second valve side opening by fluidly connecting said second conduit portion to said third conduit portion, and vice versa,
the pressure control device further comprising at least one of the following features:
said threshold pressure is between 1 bar and 10 bars,
said pressure control device comprises a first connecting portion to fluidly connect the first conduit portion to the first circuit, and a second connecting portion to connect the second conduit portion to the second circuit.

17. The pressure control device of claim 16, wherein said threshold pressure is between 1 bar and 4 bars.

18. The pressure control device of claim 16, wherein said threshold pressure is between 1 bar and 3 bars.

19. The pressure control device of claim 16, wherein
said first valve comprises a first piston housed in a first valve seat delimited by said device body and comprising at least partially said first conduit portion, wherein
said first piston is movable with respect to said device body, in said first valve seat, reversibly between:
a first conduit closing configuration, in which when the first circuit pressure is lower than the threshold pressure, said first piston forms a seal with a first wall of said first valve seat preventing a fluid passage from said first connecting portion to said third conduit portion, and
at least a first conduit opening configuration in which, when the first circuit pressure is at least equal to or higher than said threshold pressure, said first piston is spaced apart from the first wall, avoids forming a seal with the first wall and delimits a first fluid passage with said device body, which skims at least partially a head portion of said first piston allowing the fluid passage from said first connecting portion to said third conduit portion, and wherein
the pressure control device further comprises at least one of the following features or a combination thereof:
said second valve comprises a second piston housed in a second valve seat delimited by said device body and comprising at least partially said second conduit portion, wherein
said second piston is movable with respect to said device body, in said second valve seat, reversibly between:
a second conduit closing configuration, in which when the second circuit pressure is lower than the threshold pressure, said second piston forms a seal with a second wall of said second valve seat preventing a fluid passage from said second connecting portion to said third conduit portion, or vice versa, and
at least a second conduit opening configuration in which, when the second circuit pressure is at least equal to or higher than said threshold pressure, said second piston is spaced apart from the second wall, avoids forming a seal with the second wall and delimits a second fluid passage with said device body, which skims at least partially a head portion of said second piston allowing the fluid passage from said second connecting portion to said third conduit portion,
said first valve and said second valve are one-way valves;
said first valve seat extends along a longitudinal direction of first valve;
said second valve seat extends along a longitudinal direction of second valve;
said third conduit portion engages in said first valve seat and said second valve seat according to respective engagement directions which are incident and/or transverse to said longitudinal direction of first valve and said longitudinal direction of second valve;
said longitudinal direction of first valve and said longitudinal direction of second valve are parallel and/or coincident.

20. The pressure control device of claim 19, wherein
said first valve further comprises a first elastic element housed in said first valve seat, wherein
said first elastic element is interposed between said first piston and said device body, preferably a first bottom wall of said first valve seat, so as to constantly bias said first piston to said first conduit closing configuration, wherein said first elastic element is sized so that when the first circuit pressure is lower than the threshold pressure, said first piston is in said first conduit closing configuration,
said second valve further comprises a second elastic element housed in said second valve seat, wherein
said second elastic element is interposed between said second piston and said device body, preferably a second bottom wall of said second valve seat, so as to constantly bias said second piston to said second conduit closing configuration, wherein said second elastic element is sized so that when the second circuit pressure is lower than the threshold pressure, said second piston is in said second conduit closing configuration.

21. The pressure control device of claim 20, wherein
said first piston comprises a first gasket of first piston, wherein said first gasket of first piston is configured to form a seal with a first sliding wall of said first valve seat in any position of said first piston between said at least a first conduit opening configuration and said first conduit closing configuration fluidly isolating said first elastic element from said third conduit portion and/or said first circuit; and/or wherein
said second piston comprises a first gasket of second piston, wherein said first gasket of second piston is configured to form a seal with a second sliding wall of said second valve seat in any position of said second piston between said at least a second conduit opening configuration and said second conduit closing configuration fluidly isolating said second elastic element from said third conduit portion and/or said second circuit.

22. The pressure control device of claim 19, wherein
said first piston comprises a second gasket of first piston configured to form a seal with said first wall when said first piston is in said first conduit closing configuration, and wherein said second gasket of first piston is spaced apart from said first wall when said first piston is in said at least a first conduit opening configuration, opening said first fluid passage, and/or wherein
said second piston comprises a second gasket of second piston configured to form a seal with said second wall when said second piston is in said second conduit closing configuration, and wherein said second gasket of second piston is spaced apart from said second wall when said second piston is in said at least a second conduit opening configuration, opening said second fluid passage.

23. The pressure control device of claim 22, wherein
said second gasket of first piston is an annular gasket adapted to be fitted onto a first piston body or to be inserted into an axial annular seat made on a first piston head, or wherein
said first piston comprises a first piston head, wherein said first piston head comprises a first sealing surface adapted to form a geometric seal by abutting against said first wall, when said first piston is in said first conduit closing configuration, wherein the second gasket of first piston is said first sealing surface, wherein said first wall and said first sealing surface have a surface roughness such as to form a hydraulic seal when abutting against each other; and/or wherein
said second gasket of second piston is an annular gasket adapted to be fitted onto a second piston body or to be inserted into an axial annular seat made on a second piston head, or wherein
said second piston comprises a second piston head, wherein said second piston head comprises a second sealing surface adapted to form a geometric seal by axially abutting against said second wall, when said second piston is in said second conduit closing configuration, wherein said second sealing surface is spaced apart from said second wall when said second piston is in said at least a second opening configuration, wherein the second gasket of second piston is said second sealing surface, and wherein said second wall and said second sealing surface have a surface roughness such as to form a hydraulic seal when abutting against each other.

24. The pressure control device of claim 23, wherein
said first wall laterally delimits a portion of said first valve seat, preferably a first circuit side portion of said first conduit portion, and wherein
the pressure control device further comprises at least one of the following features or a combination thereof:
said first wall is a connecting wall between two segments of said first conduit portion, which forms a first section narrowing of said first conduit portion;
said second wall laterally delimits a portion of said second valve seat, preferably a second circuit side portion of said second conduit portion;
said second wall is a connecting wall between two segments of said second conduit portion, which forms a second section narrowing of said second conduit portion;
said first connecting portion partially delimits said first conduit portion with said first wall;
said second connecting portion partially delimits said second conduit portion with said second wall;
said first sealing surface and said first wall, respectively, and said second sealing surface and said second wall, respectively, form an annular geometric seal;
said first sealing surface and said second sealing surface are tapered surfaces of the first piston head and the second piston head respectively;
said first wall and said second wall are tapered surfaces having a greater taper angle than a taper angle of said first sealing surface and said second sealing surface with respect to the longitudinal direction of the respective valve seat;
said second sealing surface and said second wall, said first sealing surface and said first wall are conical surfaces, such that the respective piston head wedges into said first wall or said second wall with the respective annular gasket interposed therebetween;
said second gasket of first piston and said second gasket of second piston are annular O-rings housed in an annular seat of the first piston and of the second piston, respectively, wherein said annular seat is the axial annular seat.

25. The pressure control device of claim 20, wherein
said pressure adjusting mechanism comprises a first reinforcement in which said first elastic element is housed and a first transmission element, said first reinforcement forming a first bottom of the first valve seat, wherein
said first elastic element is connected to said first piston by said first transmission element, wherein
said first transmission element is adapted to receive a first piston engagement portion to connect to the first piston by positive coupling and/or by interference and/or by interlocking/engagement, wherein
said first transmission element is adapted to abut against a first piston thrust portion; and/or wherein
said pressure adjusting mechanism comprises a second reinforcement in which said second elastic element is housed and a second transmission element, said second reinforcement forming a second bottom of the second valve seat, wherein
said second elastic element is connected to said second piston by said second transmission element, wherein
said second transmission element is adapted to receive a second piston engagement portion to connect to the second piston by positive coupling and/or by interference and/or by interlocking/engagement, and wherein
said second transmission element is adapted to abut against a second piston thrust portion.

26. The pressure control device of claim 25, wherein
said first elastic element and said second elastic element comprise a first spring and a second spring, respectively, wherein said first spring and said second spring are a wire spring, wherein said wire spring is sized so as to allow the first piston and the second piston to respectively retract when the circuit pressure applied by the respective circuit fluid on a surface facing the first circuit or the second circuit is higher than the threshold pressure, and wherein
the pressure control device comprises at least one of the following features or a combination thereof:
said first transmission element and said second transmission element have a first T-shaped body and a second T-shaped body, respectively having a T-shaped section and a longitudinal through-hole,
said first T-shaped body has a first elongated stem and a first enlarged head,
the first elongated stem is accommodated inside turns of the first spring, wherein an end turn of the first spring abuts against an outer first-head surface of said first enlarged head,
said first elongated stem internally defines a first engagement seat to engage said first piston engagement portion by interference and/or by positive coupling and/or by engagement, wherein said first piston thrust portion abuts against an inner first-head surface of said first enlarged head,
said second T-shaped body has a second elongated stem and a second enlarged head,
the second elongated stem is accommodated inside turns of the second spring, wherein an end turn of the second spring abuts against an outer second-head surface of said second enlarged head,
said second elongated stem internally defines a second engagement seat to engage said second piston engagement portion by interference and/or by positive coupling and/or by engagement, wherein said second piston thrust portion abuts against an inner second-head surface of said second enlarged head,
the first spring and the second spring are fixed to the first bottom wall of the first valve seat and the second bottom wall of the second valve seat, respectively.

27. The pressure control device of claim 16, wherein
said first connecting portion and said second connecting portion are made in one piece separate from said device body and are sealingly connected to said device body at said at least a first circuit side opening and said at least a second circuit side opening, optionally by interposition of ring gaskets with said device body, or wherein
said first connecting portion and said second connecting portion are made in one piece with said device body and delimit said at least a first circuit side opening and said at least a second circuit side opening, respectively.

28. The pressure control device of claim 19, wherein
said device body comprises a first half-body and a second half-body, wherein
the first half-body comprises said first conduit portion, a first half of said third conduit portion, said first valve seat, wherein
the second half-body comprises said second conduit portion, a second half of said third conduit portion, said second valve seat, wherein
said first half of said third conduit portion is fluid-tightly connected to said second half of said third conduit portion, optionally by an interposed gasket, and wherein
the first half-body is constrained to the second half-body by a first pair of connecting elements, optionally the first pair of connecting elements being of screw-type, and/or a second pair of connecting elements, optionally the second pair of connecting elements being of screw-type, accommodated in respective connecting element seats made in the first half-body and the second half-body.

29. A braking system, comprising:
at least a first circuit comprising at least a first pressure chamber of a brake actuating device fluidly connected to a first braking actuation device to brake a wheel of a vehicle,
at least a second circuit comprising at least a second pressure chamber of said brake actuating device fluidly connected to a second braking actuation device to brake said wheel, and
the pressure control device of claim 15, wherein the pressure control device is connected to said first circuit and said second circuit in parallel with said first braking actuation device and said second braking actuation device and to said first pressure chamber and said second pressure chamber so that, by activating said brake actuating device, the first and second braking actuation devices are actuated with said actuating pressure, when the first circuit pressure and the second circuit pressure are higher than said threshold pressure, and one of said first braking actuation device and said second braking actuation device is actuated with said actuating pressure when one of said first circuit pressure and said second circuit pressure is lower than said threshold pressure.

30. The braking system of claim 29, wherein said brake actuating device is a lever-operated tandem master cylinder, or wherein said brake actuating device comprises two separate lever-operated brake master cylinders, and wherein the braking system further comprises at least one of the following features:
each of the first and second braking actuation devices is a brake caliper connected from opposite sides to said wheel,
said wheel is a front wheel of a motorcycle.

31. A method of controlling an actuating pressure of a brake actuating device in a braking system, wherein said braking system comprises
at least a first circuit comprising at least a first pressure chamber of the brake actuating device fluidly connected to a first braking actuation device to brake a vehicle,
at least a second circuit comprising at least a second pressure chamber of said brake actuating device fluidly connected to a second braking actuation device to brake said vehicle,
the method comprising:
providing a pressure control device comprising a first conduit portion fluidly connectable to the first circuit and a second conduit portion fluidly connectable to the second circuit,
connecting said first circuit to said second circuit with said pressure control device arranged in parallel with said first braking actuation device and said second braking actuation device and to said first pressure chamber and said second pressure chamber, by fluidly connecting the first conduit portion to the first circuit and the second conduit portion to the second circuit,
actuating the brake actuating device by compressing a first circuit fluid in the first conduit portion at a first circuit pressure and a second circuit fluid in the second conduit portion at a second circuit pressure,
until at least one of the first circuit pressure and the second circuit pressure is lower than a threshold pressure, preventing fluid passages between the first conduit portion and the second conduit portion, to sustain the first circuit pressure or the second circuit pressure to reach the actuating pressure, and actuate the first braking actuation device or the second braking actuation device with said actuating pressure,
when the first circuit pressure and the second circuit pressure are higher than a threshold pressure, fluidly connecting the first conduit portion and the second conduit portion, so as to align the first circuit pressure and the second circuit pressure with the actuating pressure and actuate with said actuating pressure the first and second braking actuation devices with said actuating pressure.
